(19) United States
(12) Patent Application Publication
(10) Pub. No.: US 2018/0272241 A1
(43) Pub. Date: Sep. 27, 2018

(54) SELF-STANDING BALANCING DEVICE, AUTOMATIC BALANCING VEHICLE AND AUTOMATIC BALANCING TOY

(71) Applicant: HON HAI PRECISION INDUSTRY CO., LTD., New Taipei (TW)

(72) Inventor: CHAU-YUAN KE, New Taipei (TW)

(21) Appl. No.: 15/867,732

(22) Filed: Jan. 11, 2018

(30) Foreign Application Priority Data
Mar. 22, 2017 (TW) 106109488

(51) Int. Cl. A63H 15/06; G05D 3/20; A63H 33/26; A63H 29/22

(52) U.S. Cl. CPC A63H 15/06; A63H 29/22; A63H 33/26; G05D 3/20

(57) ABSTRACT

An self-standing balancing device comprises a supporting frame, a connecting rod, a motor, an inertia turntable, an inertia sensor, a balance controller and a motor driver. The supporting frame comprises a first end and a second end, and the first end is suspended, and the second end is located on a supporting surface. The connecting rod is located on the supporting frame, the connecting rod comprises a third end and a fourth end, and the third end is located on the supporting surface. The motor comprises a fixing base and a rotation axis, and the fourth end is fixed on the fixing base. The inertia turntable is fixed on the rotation axis of the motor.

### CROSS-REFERENCE TO RELATED APPLICATIONS

This application claims priority to Taiwan Patent Application No. 106109488, filed on Mar. 22, 2017, the disclosure of which is incorporated herein by reference.

### FIELD

The present disclosure relates to a self-standing balancing device, an automatic balancing vehicle and an automatic balancing toy.

### BACKGROUND

At present, an automatic balancing vehicle or an automatic balancing toy only have automatic balancing function. As such, when starting the automatic balancing vehicle and the automatic balancing toy, an user need to keep the automatic balancing vehicle and the automatic balancing toy in a balanced position by hand. After starting an auto-balancing system of the automatic balancing vehicle or the automatic balancing toy, the auto-balancing system controls the balance of the automatic balancing vehicle and the automatic balancing toy. Thus, the automatic balancing vehicle or the automatic balancing toy does not have “self-standing” function before the “auto-balance” function. It is inconvenience for the user.

### BRIEF DESCRIPTION OF THE DRAWINGS

Implementations of the present technology will now be described, by way of example only, with reference to the attached figures.

FIG. 1 is a schematic view of one embodiment of a self-standing balancing device.

FIG. 2 is a schematic view of one embodiment of a connecting rod of the self-standing balancing device is pushed up.

FIG. 3 is a schematic view of one embodiment of the connecting rod of the self-standing balancing device keeping a standing balance state .

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprise” or “comprising” when utilized, means “include or including, but not necessarily limited to”; it specifically indicates open-ended inclusion or membership in the so-described combination, group, series, and the like.

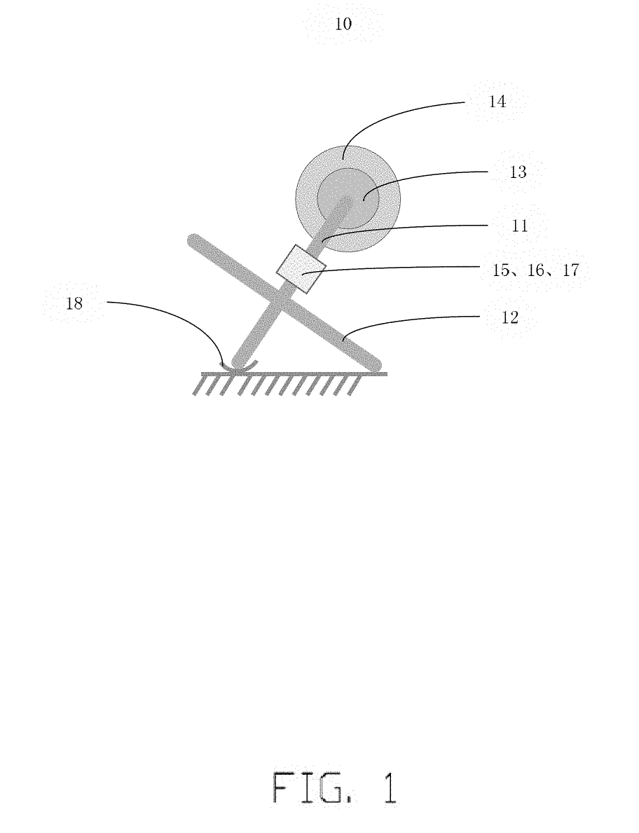

Referring to FIG. 1, one embodiment provides an self-standing balancing device 10. The self-standing balancing device 10 comprises a connecting rod 11, a supporting frame 12, a motor 13, an inertia turntable 14, an inertia sensor 15, a balance controller 16 and a motor driver 17.

The motor 13 comprises a fixing base and a rotation axis. The connecting rod 11 is located on the supporting frame 12. The connecting rod 11 comprises a first end and a second end. The first end is fixed on the fixing base of the motor 13. The second end is located on a supporting surface. The supporting frame 12 comprises a third end and a fourth end. The third end is suspended in the air, and the fourth end is located on the supporting surface. The inertia turntable 14 is fixed on the rotation axis of the motor 13 and rotates with the rotation axis. The inertia sensor 15, the balance controller 16 and the motor driver 17 are respectively located on the connecting rod 11. The inertial sensor 15 is electrically connected to the balance controller 16. The balance controller 16 is electrically connected to the motor driver 17. The motor driver 17 is electrically connected to the motor 13.

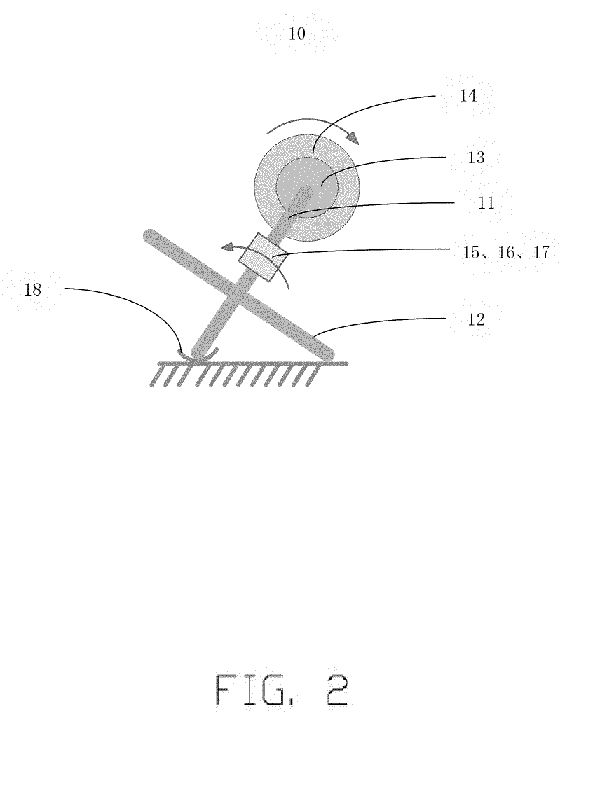

Referring to FIG. 2, the inertia turntable 14 can rotate with the rotation axis of the motor 13. When the motor 13 is accelerately rotated at an instant, the inertia turntable 14 gives the connecting rod 11 a reverse torque to rotate the connecting rod 11 in a direction reverse to the rotation direction of the motor 13. The connecting rod 11 is pushed up by the reverse torque.

In one embodiment, when the motor 13 is accelerately rotated clockwise, the connecting rod 11 generates the reverse torque, ie, a torque in the counterclockwise direction, and the connecting rod 11 rotates in the counterclockwise direction and stands up. In another embodiment, when the motor 13 is accelerately rotated counterclockwise, the connecting rod 11 generates the reverse torque, ie, a torque in the clockwise direction, and the connecting rod 11 rotates in the clockwise direction and stands up.

The inertial sensor 15 is located on the connecting rod 11 and comprises a gyroscope and an acceleration sensor. The inertial sensor 15 can recognize a connecting rod information of the connecting rod 11. The connecting rod information comprises a gravity direction, an angle or an angular velocity of the connecting rod 11. An inclination direction and an inclination angle of the connecting rod 11 can be obtained by the gravity direction and the angle of the connecting rod 11. The inertial sensor 15 may transmit the connecting rod information to the balance controller 16. In one embodiment, the inertial sensor 15 may transmit the inclination direction, the inclination angle, the angular velocity of the connecting rod 11 to the balance controller 16. The balance controller 16 comprises a control circuit and an algorithm. The balance controller 16 obtains a motor information of the motor 13 to keep the connecting rod 11 at a vertical position by calculating the connecting rod information. In one embodiment, the balance controller 16 obtains a rotation direction, a rotation speed and a rotation time of the motor 13 to keep the connecting rod 11 at the vertical position by calculating the inclination direction, the inclination angle and the angular velocity of the connecting rod 11. The balance controller 16 transmits the motor information to the motor driver 17. The motor driver 17 controls the rotation of the motor 13 according to the motor information. In one embodiment, the motor driver 17 rotates the motor 13 and controls the rotation direction, the rotation speed, the rotation time of the motor 13 to make the connecting rod 11 generate the reverse torque. The reverse torque is reverse to the direction of the rotation of the motor 13. Further, the reverse torque can push up the connecting rod 11 and keep the connecting rod 11 at the vertical position.

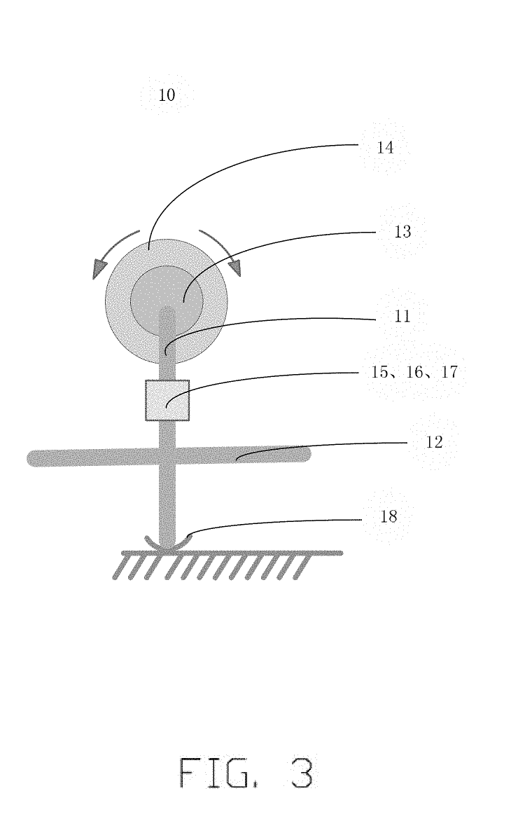

Referring to FIG. 3, after the connecting rod 11 reaching the vertical position, the inertial sensor 15 continues to detect the connecting rod information, such as, the inclination direction and the inclination angle. The inertial sensor 15 detects the connecting rod information in real time. According to the connecting rod information detected of the inertial sensor 15, the balance controller 16 and the motor driver 17 control and drive the rotation of the motor 13 to make the connecting rod 11 generate the reverse torque. The reverse torque is in a reverse direction of the rotation direction of the motor 13. The connecting rod 11 is pushed back to the vertical position by the reverse torque and keeps a standing balance state.

The self-standing balancing device 10 further comprises an anti-slip element 18. The anti-slip element 18 is located on the second end of the connecting rod 11 to prevent the connecting rod 11 from sliding on the supporting surface when the connecting rod 11 stands up. Thus, the self-standing balancing device 10 can quickly achieve self-standing and keep the standing balance state.

In the work process of the self-standing balancing device, the inertial sensor detects the connecting rod information, and the balance controller obtains the motor information to make the connecting rod to reach the vertical position by calculating the connecting rod information, and the motor driver controls the rotation of the motor to cause the connecting rod to generate the reverse torque. The reverse torque pushes the connecting rod up at the vertical position. After that, the inertial sensor detects the connecting rod information in real time, and the balance controller and the motor driver control and drive the motor to accelerately rotate clockwise or counterclockwise, so that the connecting rod can generate the reverse torque to keep the standing balance state.

One embodiment provides an automatic balancing vehicle. The automatic balancing vehicle comprises the self-standing balancing device 10. When starting the automatic balancing vehicle, the user do not need to keep the automatic balancing vehicle in the balanced position by hand. The self-standing balancing device 10 can make the automatic balancing vehicle to achieve self-standing and keep the standing balance state. Therefore, it is convenience for the user.

One embodiment provides an automatic balancing toy. The automatic balancing toy comprises the self-standing balancing device 10. When starting the automatic balancing toy, the user do not need to keep the automatic balancing toy in the balanced position by hand. The self-standing balancing device 10 can make the automatic balancing toy to achieve self-standing and keep the standing balance state. Therefore, it is convenience to the user.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may comprise some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An self-standing balancing device comprising:
a supporting frame comprising a first end and a second end, wherein the first end is suspended, and the second end is located on a supporting surface;
a connecting rod comprising a third end and a fourth end and being located on the supporting frame, wherein the third end is located on the supporting surface;
a motor comprising a fixing base and a rotation axis, wherein the fourth end of connecting rod is fixed on the fixing base;
an inertia turntable fixed on the rotation axis of the motor;
an inertia sensor configured to recognize a connecting rod information of the connecting rod;
a balance controller configured to obtain a motor information of the motor to keep the connecting rod at a vertical position by calculating the connecting rod information; and
a motor driver configured to control a rotation of the motor according to the motor information to make the connecting rod to generate a reverse torque, wherein the reverse torque pushes up the connecting rod and keeps the connecting rod at a vertical position.

2. The self-standing balancing device of claim 1, wherein the inertial sensor comprises a gyroscope and an acceleration sensor.

3. The self-standing balancing device of claim 1, wherein the balance controller comprises a control circuit and an algorithm.

4. The self-standing balancing device of claim 1, wherein the connecting rod information comprises a gravity direction, an angle and an angular velocity of the connecting rod.

5. The self-standing balancing device of claim 1, wherein the motor information comprises a rotation direction, a rotation speed and a rotation time of the motor.

6. The self-standing balancing device of claim 1, further comprising an anti-slip element, wherein the anti-slip element is located on the third end of the connecting rod.

7. The self-standing balancing device of claim 1, wherein the inertial sensor, the balance controller and the motor driver are located on the connecting rod.

8. The self-standing balancing device of claim 1, wherein the inertial sensor detects the connecting rod information in real time after the connecting rod reaching the vertical position, according to the connecting rod information detected of the inertial sensor, the balance controller and the motor driver control and drive a rotation of the motor, and the connecting rod generates the reverse torque to keep a standing balance state of the connecting rod.

9. An automatic balancing vehicle comprising:
an self-standing balancing device comprising a supporting frame, a connecting rod, a motor, an inertia turntable, an inertia sensor, a balance controller and a motor driver;
wherein the supporting frame comprises a first end and a second end, and the first end is suspended, and the second is located on a supporting surface;
the connecting rod is located on the supporting frame, the connecting rod comprises a third end and a fourth end, and the third end is located on the supporting surface;
the motor comprises a fixing base and a rotation axis, and the fourth end of connecting rod is fixed on the fixing base;
the inertia turntable is fixed on the rotation axis of the motor;
the inertia sensor is configured to recognize a connecting rod information of the connecting rod;
the balance controller is configured to obtain a motor information of the motor to keep the connecting rod at a vertical position by calculating the connecting rod information; and
the motor driver is configured to control a rotation of the motor according to the motor information to make the connecting rod to generate a reverse torque, and the torque pushes up the connecting rod and keeps the connecting rod at a vertical position.

10. The automatic balancing vehicle of claim 9, wherein the inertial sensor comprises a gyroscope and an acceleration sensor.

11. The automatic balancing vehicle of claim 9, wherein the balance controller comprises a control circuit and an algorithm.

12. The automatic balancing vehicle of claim 9, wherein the connecting rod information comprises a gravity direction, an angle and an angular velocity of the connecting rod.

13. The automatic balancing vehicle of claim 9, wherein the motor information comprises a rotation direction, a rotation speed and a rotation time of the motor.

14. The automatic balancing vehicle of claim 9, further comprising an anti-slip element, wherein the anti-slip element is located on the third end of the connecting rod.

15. The automatic balancing vehicle of claim 9, wherein the inertial sensor, the balance controller and the motor driver are located on the connecting rod.

16. The automatic balancing vehicle of claim 9, wherein the inertial sensor detects the connecting rod information in real time after the connecting rod reaching the vertical position, according to the connecting rod information detected of the inertial sensor, the balance controller and the motor driver control and drive a rotation of the motor, and the connecting rod generates the reverse torque to keep a standing balance state of the connecting rod.

17. An automatic balancing toy comprising:
an self-standing balancing device comprising a supporting frame, a connecting rod, a motor, an inertia turntable, an inertia sensor, a balance controller and a motor driver;
wherein the supporting frame comprises a first end and a second end, and the first end is suspended, and the second is located on a supporting surface;
the connecting rod is located on the supporting frame, the connecting rod comprises a third end and a fourth end, and the third end is located on the supporting surface;
the motor comprises a fixing base and a rotation axis, and the fourth end of connecting rod is fixed on the fixing base;
the inertia turntable is fixed on the rotation axis of the motor;
the inertia sensor is configured to recognize a connecting rod information of the connecting rod;
the balance controller is configured to obtain a motor information of the motor to keep the connecting rod at a vertical position by calculating the connecting rod information; and
the motor driver is configured to control a rotation of the motor according to the motor information to make the connecting rod to generate a reverse torque, and the torque pushes up the connecting rod and keeps the connecting rod at a vertical position.

18. The automatic balancing toy of claim 17, wherein the inertial sensor comprises a gyroscope and an acceleration sensor.

19. The automatic balancing toy of claim 17, wherein the balance controller comprises a control circuit and an algorithm.

20. The automatic balancing toy of claim 17, wherein the connecting rod information comprises a gravity direction, an angle and an angular velocity of the connecting rod.
